(19) United States
(12) Patent Application Publication
(10) Pub. No.: US 2011/0109810 A1
(43) Pub. Date: May 12, 2011

(54) METHOD AN APPARATUS FOR FAST CHANNEL CHANGE USING A SCALABLE VIDEO CODING (SVC) STREAM

(76) Inventors: John Qiang Li, Belle Mead, NJ (US); Xiuping Lu, Hillsborough, NJ (US); Zhenyu Wu, Plainsboro, NJ (US)

(21) Appl. No.: 12/737,415

(22) PCT Filed: Jul. 28, 2009
(86) PCT No.: PCT/US2009/004360

§ 371 Date: Jan. 11, 2011

Related U.S. Application Data
(60) Provisional application No. 61/084,068, filed on Jul. 28, 2008.

(51) Int. Cl. H04N 7/26; H04N 5/44; H04N 5/50

(52) U.S. Cl. 348/731; 375/240.25; 348/725; 375/E07.027; 348/E05.096; 348/E05.097

(57) ABSTRACT

There are provided methods and apparatus for fast channel change when changing the channel from a channel being viewed full screen to a channel being viewed in a secondary display window (e.g., picture-in-picture (PIP) window). In one implementation, the base layer stream of the SVC encoded stream is used as the secondary stream for the secondary display and the corresponding enhancement layer stream is used as the corresponding regular stream. Upon channel change request, the decoded base layer picture of the SVC encoded stream is up-sampled, and the up-sampled base layer picture is displayed full screen while receiving the corresponding SVC enhancement layer stream. Then, the up-sampled base layer picture is replaced by the decoded enhancement layer picture upon confirmation of successful receiving and decoding of an enhancement layer instantaneous decode refresh (IDR) frame. In another implementation, the last GOP of enhancement layer stream corresponding to a base layer stream being viewed in the secondary display window is buffered without decoding, and upon a channel change request to the secondary video display window channel, the buffered packets are decoded and displayed immediately while the decoder continues to receive and decode all frames in the corresponding base and enhancement layer streams.

This application claims the benefit of U.S. Provisional Application Ser. No. 61/084,068, filed Jul. 28, 2008, which is incorporated by reference herein in its entirety.

This application is related to the following co-pending, commonly owned, U.S. patent applications: (1) Ser. No. ______ entitled METHOD AND APPARATUS FOR FAST CHANNEL CHANGE FOR DIGITAL VIDEO filed on Jul. 25, 2007 as an international patent application (Filing No. PCT/US2007/016788, Thomson Docket No. PU060146); (2) Ser. No. ______ entitled AN ENCODING METHOD TO IMPROVE EFFICIENCY IN SVC FAST CHANNEL CHANGE filed on Jan. 16, 2009 as an international patent application (Filing No. PCT/US2009/000325, Thomson Docket No. PU080128); (3) Ser. No. ______ entitled AN RTP PACKETIZATION METHOD FOR FAST CHANNEL CHANGE APPLICATIONS USING SVC filed on Jan. 29, 2009 as an international patent application (Filing No. PCT/US08/006,333, Thomson Docket No. PU080133); (4) Ser. No. ______ entitled A SCALABLE VIDEO CODING METHOD FOR FAST CHANNEL CHANGE AND INCREASED ERROR RESILIENCE filed on Oct. 30, 2008 as an international patent application (Filing No. PCT/US2008/012303, Thomson Docket No. PU070272); and (5) Ser. No. ______ entitled METHOD AND APPRATUS FAST CHANNEL CHANGE USING A SCALABLE VIDEO CODING (SVC) STREAM filed on Jul. XX, 2009 as an international patent application (Filing No. ______, Thomson Docket No. PU080135).

The present principles relate generally to digital video communication systems and, more particularly, to methods and an apparatus for fast channel change using a scalable video coding (SVC) stream.

Scalable Video Coding (SVC) has many advantages over classical Advanced Video Coding (AVC) (see, e.g., ITU-T Recommendation H.264 Amendment 3: “Advanced video coding for generic audiovisual services: Scalable Video Coding”). Scalability in SVC can apply to the temporal, spatial and quality (signal-to-noise ratio) domains. An SVC stream usually comprises one base layer and one or more enhancement layers. The base layer stream can be independently decoded but any enhancement layers can only be decoded together with the base layer and other dependent enhancement layers. Thus when referring a decoded enhancement layer frame or picture in the text, it means it is decoded by using the date received from both enhancement layer and its corresponding base layer.

Other than the inventive concept, the elements shown in the figures are well known and will not be described in detail. More specifically, familiarity with television broadcasting via radio frequencies (RF)/cable/Internet, television receivers, and video encoding/decoding is assumed and is not described in detail herein. For example, other than the inventive concept, familiarity with current and proposed recommendations for TV standard—such as NTSC (National Television Systems Committee), PAL (Phase Alternation Lines), SECAM (Sequential Couleur Avec Memoire) and ATSC (Advanced Television Systems Committee) (ATSC), Integrated Services Digital Broadcasting (ISDB), Chinese Digital Television System (GB) and DVB-H—is assumed. Likewise, other than the inventive concept, other transmission concepts—such as eight-level vestigial sideband (8-VSB), Quadrature Amplitude Modulation (QAM), and Quadrature Phase-Shift Keying (QPSK)—and receiver components—such as a radio-frequency (RF) front-end (such as a low noise block, tuners, down converters, etc.), demodulators, correlators, leak integrators and squarer—are assumed. Further, other than inventive concept, other video communication concepts—such as IPTV multicast system, bi-directional cable TV system, Internet protocol (IP) and Internet Protocol Encapsulator (WE)—are assumed. Similarly, other than the inventive concept, formatting and encoding/decoding methods—such as Moving Picture Expert Group (MPEG)-2 Systems Standard (ISO/IEC 13818-1), H.264/MPEG-4 Advanced Video Coding (AVC) and H.264/MPEG-4 Scalable Video Coding (SVC)—for generating transport bit streams are well-known and not described herein. Finally, like-numbers on the figures represent similar elements.

Modern video compression techniques can achieve a very high degree of compression by utilizing the temporal correlation of video frames. In a group of pictures (GOP), only one picture is entirely intra coded and the remaining pictures are encoded wholly or partially based on redundancy shared with other pictures. An intra-coded picture (I) uses only redundancy within itself to produce compression. Inter-coded pictures (B or P pictures), however, must be decoded after the related intra coded picture(s) is/are decoded. Since I pictures typically require 3 to 10 times more bits than a B or P picture, they are encoded much less frequently in the bit stream in order to reduce the overall bit rate. In general, for the same video sequence, a stream encoded with a relatively large number of pictures included within a GOP (e.g. >2 seconds worth of video) has a significantly lower bit rate than the one encoded with a short (e.g., <=1 second worth of video) GOP size.

However, using a GOP size, which is relatively large, has an unintentionally adverse effect on the channel change latency. That is, when a receiver tunes to a video program, the receiver must wait until the first I picture is received before any pictures can be decoded for display. Less frequent I pictures can cause longer delays in a channel change. Most broadcast systems transmit I pictures frequently, for example, every 1 second or so, in order to limit the channel change delay time due to the video compression system. Needless to say, more frequent I pictures significantly increase the overall transmission bitrate.

In the field of digital video multicasting, such as an interactive IPTV multicast systems, the channel change latency, due to the waiting time interval for an Instantaneous Decoder Refresh (IDR) frame in a GOP, has been a troublesome problem to viewers as the problem considerably degrade their overall quality of experience (QoE). As described above, because an IDR frame includes a significantly larger amount of bits to encode than P or B frame, having more frequent IDR frames in a regular video stream is not a desirable solution in consideration of the limitation of the total GOP bitrate.

A potential solution to such a channel change latency problem may be to employ a buffering device within the multicast network system itself in order to buffer the latest portion of the broadcast stream. Then the system unicasts the buffered video contents to a receiver (such as a set-top box), starting from an I picture, when a user sends a channel change request to the multicast system from his/her receiver. Here, the unicast stream may be sent either with a transmission rate faster than the normal bit rate or on the normal transmission bitrate. After an I picture of the buffered stream is received, then the receiver switches back to the broadcast stream corresponding to the buffered video stream.

A remarkable disadvantage of this solution is that the network system requires complex middleware support. Furthermore, the system also requires the necessary hardware to store the unicast streams. As a result, the bandwidth and storage requirement for the multicast network need to be scaled up as a total number of concurrent users increases. Needless to say, this undesirably imposes additional costs on the network providers.

Another solution to the problem is to transmit a channel change stream that includes low-resolution IDR frames more frequently than a regular video stream along with the corresponding regular video stream during a channel change operation as disclosed in the published International Patent Application (WO 2008/013883, entitled “Method and Apparatus for Fast Channel Change for Digital Video”, published 31 Jan. 2008). It is mentioned therein that such a channel change stream may be utilized for broadcasting secondary program contents, such as PIP or POP video contents.

The present application addresses a channel-change latency problem that may occur under multi-picture digital television environment. More specifically, the problem occurs in conjunction with a channel change operation between the program contents of a sub picture (e.g., a PIP picture) and those of a main picture. For example, in a channel change operation, a viewer may attempt to display the program contents of a sub picture currently displayed within a sub-picture window (e.g., a PIP window) in full screen or over a majority of the viewing area of the display screen as a new main picture. For example, in another channel operation, a viewer may attempt to swap the program contents of a sub picture with those of the main picture. Accordingly, there is a need for a method and apparatus that avoids the aforementioned channel-change latency problems and improves the QoE of viewers. The present invention addresses these and/or other issues.

In accordance with one implementation of the present invention, an SVC base layer is used as a secondary video stream, while the enhancement layer is used as its corresponding regular stream when an SVC encoder is used in the streaming. The secondary video stream is utilized for fast channel change. The present invention uses the SVC base layer as the secondary video stream as compared to the use of two separate and distinct AVC streams.

The invention describes methods to make use of the secondary video stream derived from the SVC base layer to up-sample and display the secondary video stream in full screen while waiting for the IDR frame in the regular stream to achieve the fast channel change.

According to another implementation, the SVC enhancement layer is cached/buffered when a channel is selected to be viewed in the secondary display window (e.g., PIP window). When the user changes the channel to the channel being viewed in the secondary window,

According to one implementation, the method includes up-sampling a base layer in an SVC encoded stream as a current secondary video stream being displayed in a secondary video display window, displaying the up-sampled secondary stream full screen upon request to change the channel to a channel being viewed in the secondary video display window, determining whether an instantaneous decoder refresh (IDR) frame in an enhancement layer of the SVC encoded stream corresponding to the secondary video stream being viewed is received and decoded; and switching the display from an up-sampled base layer frame to a corresponding enhancement layer frame when it is determined that the IDR frame is received and decoded.

According to another implementation, the apparatus includes a receiver configured to receive and decode a base layer of an SVC encoded stream as a secondary video stream and an enhancement layer of the SVC encoded stream as a corresponding regular stream of digital video and to display the same in accordance with a viewer selection, a processor connected to the receiver, a memory connected to the processor, wherein the processor and memory are configured to up-sample the base layer the source of the secondary video stream when a channel is being viewed in a secondary video display window and to display the up-sampled secondary video stream full screen immediately upon a viewer request to change the channel to the channel being viewed in the secondary video display window.

According to another implementation, the method includes requesting to display a channel represented by a secondary video stream in a secondary video display window, said secondary video stream comprising a base layer stream from an SVC encoded video stream, sending a request to retrieve enhancement layer packets of the SVC encoded stream corresponding to base layer secondary video stream for the channel being displayed in the secondary video display window, buffering all packets of the enhancement layer of latest group of pictures (GOP) without decoding the packets, detecting a channel change request to view the channel being displayed in the secondary video display window; and decoding all frames using the buffered packets from the beginning of the stored latest GOP.

According to yet another implementation, the apparatus includes a receiver configured to receive and decode a base layer of an SVC encoded stream as a secondary video stream and an enhancement layer of the SVC encoded stream as a corresponding regular stream of digital video and to display the same in accordance with a viewer selection, a processor integrated into the receiver, and a memory connected to the processor, wherein the processor and memory are configured to retrieve the base layer stream as the secondary video stream for a channel being displayed in a secondary display window and to buffer all packets of the enhancement layer of the of the latest group of pictures (GOP) without decoding the same.

These and other aspects, features and advantages of the present principles will become apparent from the following detailed description of exemplary embodiments, which is to be read in connection with the accompanying drawings.

The present principles may be better understood in accordance with the following exemplary figures, in which:

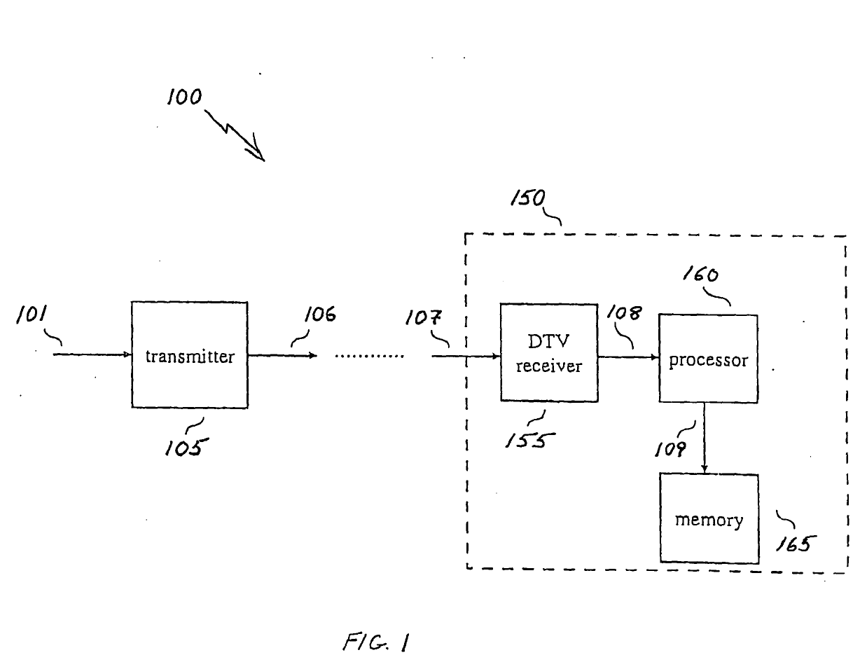

FIG. 1 is a block diagram for an exemplary end-to-end architecture in accordance with the principles of the present invention;

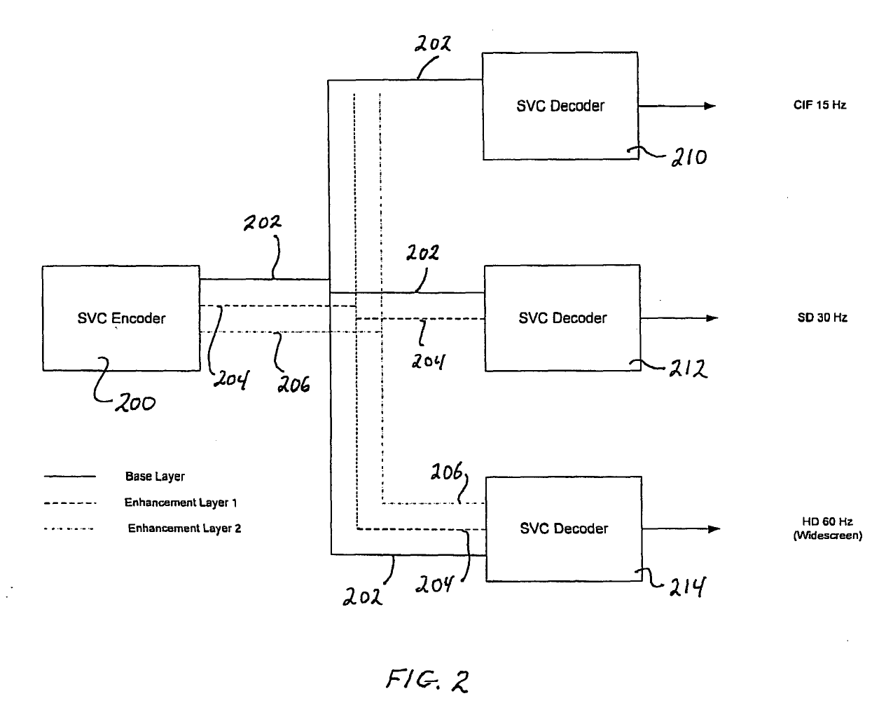

FIG. 2 is a block diagram of an SVC Encoder and corresponding SVC Decoders;

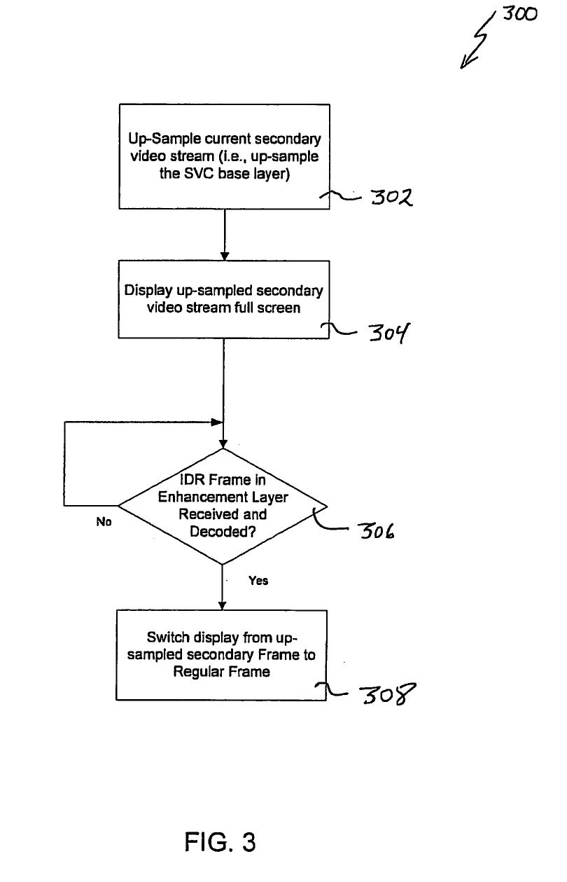

FIG. 3 is a flow diagram for the method for fast channel change according to an implementation of the present principles; and

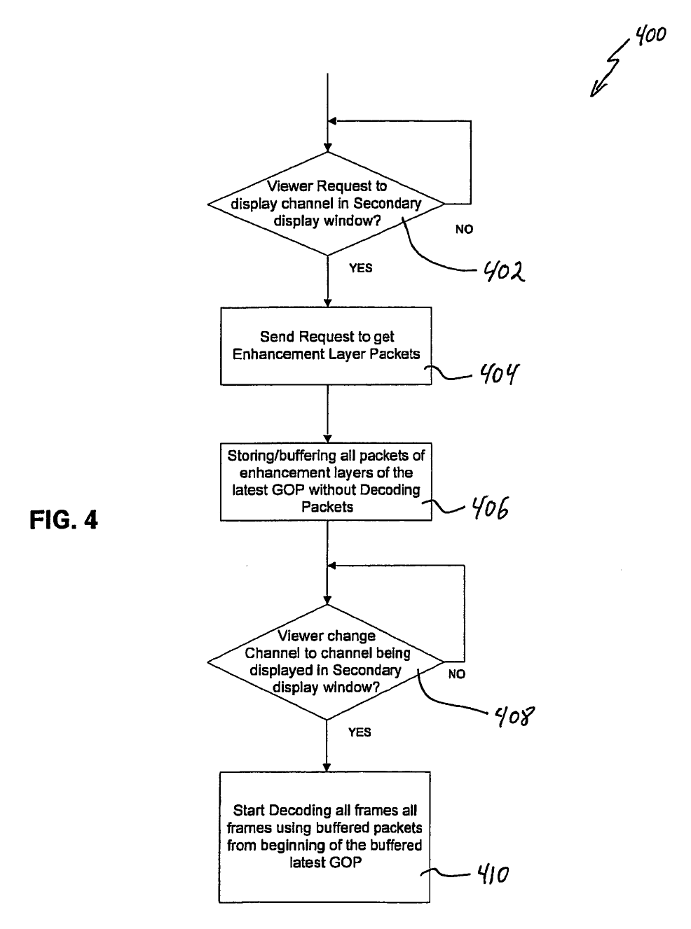

FIG. 4 is a flow diagram for the method for fast channel change according to another implementation of the present invention.

The present principles are directed to methods and apparatus for fast channel change for digital video.

The present description illustrates the present principles. It will thus be appreciated that those skilled in the art will be able to devise various arrangements that, although not explicitly described or shown herein, embody the present principles and are included within its spirit and scope.

All examples and conditional language recited herein are intended for pedagogical purposes to aid the reader in understanding the present principles and the concepts contributed by the inventor(s) to furthering the art, and are to be construed as being without limitation to such specifically recited examples and conditions.

Moreover, all statements herein reciting principles, aspects, and embodiments of the present principles, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative circuitry embodying the present principles. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (“DSP”) hardware, read-only memory (“ROM”) for storing software, random access memory (“RAM”), and non-volatile storage.

Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The present principles as defined by such claims reside in the fact that the functionalities provided by the various recited means are combined and brought together in the manner which the claims call for. It is thus regarded that any means that can provide those functionalities are equivalent to those shown herein.

Reference in the specification to “one embodiment” or “an embodiment” of the present principles means that a particular feature, structure, characteristic, and so forth described in connection with the embodiment is included in at least one embodiment of the present principles. Thus, the appearances of the phrase “in one embodiment” or “in an embodiment” appearing in various places throughout the specification are not necessarily all referring to the same embodiment.

It is to be appreciated that while one or more embodiments of the present principles are described herein with respect to a Digital Subscriber Line (DSL) system, the present principles are not limited solely to DSL systems and, thus, may be used with respect to any media transmission system that uses a transport stream including, but not limited to, MPEG-2 transport streams. Thus, for example, the present principles may be utilized with respect to cable television systems, satellite television systems, and so forth, while maintaining the spirit of the present principles.

As noted above, the present invention is directed to methods and apparatus for fast channel change in digital video, and in particular, the fast channel change to a channel being viewed in a secondary video display window (e.g., a PIP window). Advantageously, the present principles provide a scalable solution for large scale Internet Protocol Television (IPTV) deployment.

Therefore, in accordance with the principles of various embodiments of the present invention, the channel change latency in a MPEG-2 transport stream (TS) based digital video broadcast system is significantly reduced.

In accordance with an embodiment the reduction in channel change latency is achieved by utilizing an SVC base layer as the secondary video stream as and utilizing this secondary video stream for fast channel change.

Scalable Video Coding (SVC) has many advantages over Advanced Video Coding (AVC). The present invention teaches using SVC's base layer as the secondary video stream instead of a separate low-resolution AVC stream in the digital video multicasting networks. In addition, and in accordance with the principles of the invention, more frequent IDR (Instantaneous Decoder Refresh) frames are used in the base layer encoding than enhancement layers for the fast channel change when a channel shown in a secondary video display window is selected to be the next channel.

Also described herein are methods to cache all the enhancement layer packets of the latest GOP (Group of Pictures) when the channel is shown in secondary video display window for use with the fast channel change when the channel shown in secondary video display window is selected to be the next channel.

The use of a secondary video display window is a popular feature to show a second channel in a window while watching another channel. This feature is commonly referred to as picture-in-picture (PIP) or picture-out-picture (POP) can include a split screen or other version of showing a second channel while watching a primary channel. In case of AVC encoding, a secondary video stream (e.g., a PIP stream) and its corresponding regular stream are encoded separately and transported separately in different IP (Internet Protocol) streams. Thus, it is not efficient to code the same content/twice for the PIP application.

Channel change delay due to the waiting interval for an IDR frame in a GOP to come has been a serious problem as it degrades the quality of experience (QoE) of viewers. Since IDR frame costs significant amount of bits to encode compared to P frames or B frames, having more frequent IDR frames in the regular stream is not a desirable solution to the problem due to the limitation of the total bitrates of a GOP. One solution to this problem is to use a low resolution with more frequent DR frames for the fast channel change, and such a solution has been disclosed in the published international application WO2008/013883 (published Jan. 31, 2008) as mentioned above

The present application discloses a new solution to the channel-change latency problem under the environment of multi-picture display where the SVC encoding is employed. In accordance with the principles of the invention, the SVC base layer is used as a secondary video stream and the enhancement layers as its corresponding regular stream when the SVC encoder is used in the streaming. One of the advantages of this implementation is to save the streaming bandwidth which is otherwise required to have a separate and distinct low resolution AVC stream for the secondary video display (e.g., PIP).

Those of skill in the art will recognize that Channel change in digital video multicasting networks starts with a request to join the multicast group and then the video decoder tunes in to that group to wait for the first IDR frame to decode and display on full screen. The delay of this process thus depends on mainly the frequency of IDR frames. For example, if an IDR frame appears once every 48 frames in a GOP for a typical 24 fps frame rate stream, the decoder could start to receive the first frame in any frame of the GOP and has to discard all the previous frames before the first DR frame. Thus, the channel change delay could be as long as 2 seconds.

In order to perform a fast channel-change operation in accordance with the principles of the present invention, the GOP structures of the base and enhancement layers of the SVC encoder exhibit the characteristics mentioned below. That is, the base layer has more IDR frames periodically than its regular stream or the base layer stream has a shorter GOP than the regular stream. For example, there is one IDR frame in every 12 frames in a base layer stream (GOP=0.5 seconds) and one IDR frame in every 48 frames in the corresponding enhancement layer stream (GOP=2 second).

With such an arrangement of the GOP size in the base and enhancement layer streams, two methods are proposed for the fast channel change in a scenario when a viewer is changing a channel to the channel that is currently being shown in the secondary video display window.

An illustrative system in accordance with the principles of the invention is shown in FIG. 1. A transmitter 105 receives a signal 101 for providing a broadcast signal 106 in accordance with the principles of the invention. A receiving apparatus 150 receives the broadcast signals in accordance with the principles of the invention as represented by received signal 107. The receiving apparatus can be, for example, a cell phone, mobile TV, set-top box, digital TV (DTV), etc. with our without a display. Receiving apparatus 150 comprises DTV receiver 155, processor 160 and memory 165. As such, receiving apparatus 150 is a processor-based system. DTV receiver 155 receives signal 107 as described above and recovers therefrom signal 108, which is processed by processor 160, e.g., in accordance with the herein described methods for providing a fast channel change.

FIG. 2 shows a block diagram of an SVC encoder and corresponding decoders. Those of skill in the art will recognize that the SVC encoder 200 is capable of outputting a base layer 202, a first enhancement layer 204 and a second enhancement layer 204. Based on the connected display device, the SVC decoders 210, 212, 214 utilize the requisite SVC layers. By way of example, SVC decoder 210 utilizes only the base layer stream 202 to display the video in a CIF 15 Hz device (e.g., a mobile phone). SVC decoder 212 utilizes both the base layer 202 and the first enhancement layer 204 in order to provide the standard definition (SD) display, and SVC decoder 214 utilizes the base layer 202, the first enhancement layer 204 and the second enhancement layer 206 in order to output the high definition (HD) display to the corresponding display device.

Referring to FIG. 3, there is shown the method 300 for fast channel change according to an implementation of the present invention. As shown, the method starts by up-sampling the current secondary video stream immediately while the decoder is waiting for the IDR frame in the enhancement layer to decode (step 302). The up-sampled secondary video stream is displayed full screen (304) when the user requests the channel change to the secondary video stream. A determination (306) is then made as to whether the IDR frame in the enhancement layer is received and decoded (308). Once the IDR frame in the enhancement layer is received and decoded, the decoder will switch the display (308) from the up-sampled PIP frame to the regular frame.

Using this method in the example above, for example, the channel change delay can be reduced from maximum of 2 second to 0.5 second. It is understandable that during the transition period for up to 2 second the video quality of up-sampled secondary video stream is not as good as the regular video. But this gives the viewer a better experience than a slow channel change with frozen or black screen whiling waiting.

FIG. 4 shows a second method for fast channel change according to an implementation of the present invention. The method 400 starts by determining (402) whether the viewer has selected a channel to display in the secondary display window (e.g., a PIP window). When this is the case, method sends a request (404) to get the enhancement layer packets from the SVC stream (the packets could be in a separate or the same IP stream as the SVC base layer). The decoder then stores (406) all the packets of the enhancement layers of the latest GOP without decoding them. When viewer changes the channel to the channel being displayed in the secondary video window (408), the decoder then uses the buffered enhancement layer packets to start decoding all the frames from the beginning of the buffered latest GOP (410) and displaying the same full screen.

As described above in the first method 300, the decoder can start displaying the up-sampled secondary video stream immediately while starting to decode all the corresponding regular streams until it has the latest regular frame decoded that can seamlessly replace the up-sampled secondary video stream. In this method 400, the delay to switch to the regular stream is only due to the decoding speed of the receiver hardware and thus the transition period from up-sampled secondary video stream to the regular stream is usually much shorter than method 300 if the receiver hardware has adequate computing power.

Those of skill in the art will recognize that the seamless switch is possible do to the nature of SVC. Comparing method 400 to method 300, method 300 requires the additional bandwidth to receive the enhancement packets but it does not require the decoder to decode the enhancement packets until the viewer actually switches to that channel. Thus, it does not add extra computing burden to the decoder.

In view of the above, the foregoing merely illustrates the principles of the invention and it will thus be appreciated that those skilled in the art will be able to devise numerous alternative arrangements which, although not explicitly described herein, embody the principles of the invention and are within its spirit and scope. For example, although illustrated in the context of separate functional elements, these functional elements may be embodied in one, or more, integrated circuits (ICs). Similarly, although shown as separate elements, any or all of the elements may be implemented in a stored-program-controlled processor, e.g., a digital signal processor, which executes associated software, e.g., corresponding to one, or more, of steps. Further, the principles of the invention are applicable to other types of communications systems, e.g., satellite, Wireless-Fidelity (Wi-Fi), cellular, etc. Indeed, the inventive concept is also applicable to stationary or mobile receivers. It is therefore to be understood that numerous modifications may be made to the illustrative embodiments and that other arrangements may be devised without departing from the spirit and scope of the present invention.

In view of the above, the foregoing merely illustrates the principles of the invention and it will thus be appreciated that those skilled in the art will be able to devise numerous alternative arrangements which, although not explicitly described herein, embody the principles of the invention and are within its spirit and scope. For example, although illustrated in the context of separate functional elements, these functional elements may be embodied in one, or more, integrated circuits (ICs). Similarly, although shown as separate elements, any or all of the elements may be implemented in a stored-program-controlled processor, e.g., a digital signal processor, which executes associated software, e.g., corresponding to one, or more, of steps. Further, the principles of the invention are applicable to other types of communications systems, e.g., satellite, Wireless-Fidelity (Wi-Fi), cellular, etc. Indeed, the inventive concept is also applicable to stationary or mobile receivers. It is therefore to be understood that numerous modifications may be made to the illustrative embodiments and that other arrangements may be devised without departing from the spirit and scope of the present invention.

These and other features and advantages of the present principles may be readily ascertained by one of ordinary skill in the pertinent art based on the teachings herein. It is to be understood that the teachings of the present principles may be implemented in various forms of hardware, software, firmware, special purpose processors, or combinations thereof.

Most preferably, the teachings of the present principles are implemented as a combination of hardware and software. Moreover, the software may be implemented as an application program tangibly embodied on a program storage unit. The application program may be uploaded to, and executed by, a machine comprising any suitable architecture. Preferably, the machine is implemented on a computer platform having hardware such as one or more central processing units (“CPU”), a random access memory (“RAM”), and input/output (“I/O”) interfaces. The computer platform may also include an operating system and microinstruction code. The various processes and functions described herein may be either part of the microinstruction code or part of the application program, or any combination thereof, which may be executed by a CPU. In addition, various other peripheral units may be connected to the computer platform such as an additional data storage unit and a printing unit.

It is to be further understood that, because some of the constituent system components and methods depicted in the accompanying drawings are preferably implemented in software, the actual connections between the system components or the process function blocks may differ depending upon the manner in which the present principles are programmed. Given the teachings herein, one of ordinary skill in the pertinent art will be able to contemplate these and similar implementations or configurations of the present principles.

Although the illustrative embodiments have been described herein with reference to the accompanying drawings, it is to be understood that the present principles is not limited to those precise embodiments, and that various changes and modifications may be effected therein by one of ordinary skill in the pertinent art without departing from the scope or spirit of the present principles. All such changes and modifications are intended to be included within the scope of the present principles as set forth in the appended claims.

1. A method comprising:
up-sampling a base layer in an SVC encoded stream as a current secondary video stream being displayed in a secondary video display window;
displaying the up-sampled secondary stream full screen upon request to change the channel to a channel being viewed in the secondary video display window;
determining whether an instantaneous decoder refresh (IDR) frame in an enhancement layer of the SVC encoded stream corresponding to the secondary video stream being viewed is received and decoded; and
switching the display from an up-sampled base layer frame to a corresponding enhancement layer frame when it is determined that the IDR frame is received and decoded.

2. The method of claim 1, wherein said up-sampling is performed in response to a viewers request to change the channel to a channel being viewed in a secondary display window

3. The method of claim 1, wherein the base layer secondary video stream includes more IDR frames than its corresponding enhancement layer stream.

4. The method of claim 1, wherein the base layer secondary video stream has a shorter group of pictures (GOP) than the enhancement layer corresponding to the base layer secondary video stream.

5. An apparatus comprising:
a receiver configured to receive and decode a base layer of an SVC encoded stream as a secondary video stream and an enhancement layer of the SVC encoded stream as a corresponding regular stream of digital video and to display the same in accordance with a viewer selection;
a processor connected to the receiver; and
a memory connected to the processor;
wherein the processor and memory are configured to up-sample the base layer the source of the secondary video stream when a channel is being viewed in a secondary video display window and to display the up-sampled secondary video stream full screen immediately upon a viewer request to change the channel to the channel being viewed in the secondary video display window;

6. The apparatus according to claim 5, wherein processor is configured to determine whether an Instantaneous Decoder Refresh (IDR) frame in the enhancement layer of the SVC encoded stream corresponds to the up-sampled base layer stream and to switch the display from the up-sampled base layer stream to the corresponding enhancement layer stream when it is determined that the IDR frame is received and decoded.

7. The apparatus according to claim 5, wherein said receiver further comprises a DTV receiver.

8. The apparatus according to claim 5, wherein the base layer secondary video stream includes more IDR frames than its corresponding enhancement layer stream.

9. The apparatus according to claim 5, wherein the base layer secondary video stream has a shorter group of pictures (GOP) than the enhancement layer corresponding to the base layer secondary video stream.

10. An apparatus comprising:
means for up-sampling a base layer in an SVC encoded stream as a current secondary video stream being displayed in a secondary video display window;
means for providing a video signal for displaying the up-sampled secondary stream full screen upon request to change the channel to a channel being viewed in the secondary video display window;
means for determining whether an instantaneous decoder refresh (IDR) frame in an enhancement layer the SVC encoded stream corresponding to the secondary video stream being viewed is received and decoded; and
means for switching the display from an up-sampled base layer frame to a corresponding enhancement layer frame when it is determined that the IDR frame is received and decoded.

11. The apparatus according to claim 10, wherein said up-sampling means is responsive to a viewer's request to change the channel to a channel being viewed in a secondary display window, said up-sampling being performed while a decoder is sending a request for an enhancement layer stream corresponding to the base layer secondary video stream.

12. The apparatus according to claim 10, wherein the base layer secondary video stream includes more IDR frames than its corresponding enhancement layer stream.

13. The apparatus according to claim 10, wherein the base layer secondary video stream has a shorter group of pictures (GOP) than the enhancement layer corresponding to the base layer secondary video stream.

14. A method comprising the steps of:
requesting to display a channel represented by a secondary video stream in a secondary video display window, said secondary video stream comprising a base layer stream from an SVC encoded video stream;
sending a request to retrieve enhancement layer packets of the SVC encoded stream corresponding to base layer secondary video stream for the channel being displayed in the secondary video display window;
buffering all packets of the enhancement layer of latest group of pictures (GOP) without decoding the packets;
detecting a channel change request to view the channel being displayed in the secondary video display window; and
decoding all frames using the buffered packets from the beginning of the stored latest GOP.

15. The method of claim 14, wherein the base layer of the SVC encoded stream comprises more instantaneous decode refresh (IDR) frames than its corresponding enhancement layer stream.

16. The method of claim 14, wherein the base layer of the SVC encoded stream comprises a shorter group of pictures (GOP) than its corresponding enhancement layer stream.

17. The method of claim 14, wherein said decoding further comprises decoding all frames in the corresponding enhancement layer stream at the same time while decoding and displaying the buffered packets.

18. An apparatus comprising:
a receiver configured to receive and decode a base layer of an SVC encoded stream as a secondary video stream and an enhancement layer of the SVC encoded stream as a corresponding regular stream of digital video and to display the same in accordance with a viewer selection;
a processor integrated into the receiver; and
a memory connected to the processor;
wherein the processor and memory are configured to retrieve the base layer stream as the secondary video stream for a channel being displayed in a secondary display window and to buffer all packets of the enhancement layer of the of the latest group of pictures (GOP) without decoding the same.

19. The apparatus according to claim 18, wherein said receiver further comprises a DTV receiver.

20. The apparatus according to claim 18, wherein the processor detects a channel change request to view the channel being displayed in the secondary video display window, and in response to a detected channel change request, said processor causes said receiver to decode the buffered enhancement layer packets and display the same immediately.

21. The apparatus according to claim 18, wherein the base layer of the SVC encoded stream comprises more instantaneous decode refresh (IDR) frames than its corresponding enhancement layer stream.

22. The apparatus according to claim 18, wherein the base layer of the SVC encoded stream comprises a shorter group of pictures (GOP) than its corresponding enhancement layer stream.

23. The apparatus according to claim 18, wherein the receiver is further configured to decode all frames in the enhancement layer stream at the same time while decoding and displaying the buffered enhancement layer packets.

24. An apparatus comprising:
means for requesting to display a channel represented by a secondary video stream in a secondary video display window, said secondary video stream comprising a base layer stream from an SVC encoded video stream;
means for sending a request to retrieve enhancement layer packets of the SVC encoded stream corresponding to base layer secondary video stream for the channel being displayed in the secondary video display window;
means for buffering all packets of the enhancement layer of latest group of pictures (GOP) without decoding the packets;
means for detecting a channel change request to view the channel being displayed in the secondary video display window; and
means for decoding all frames using the buffered packets from the beginning of the stored latest GOP.

25. The apparatus according to claim 24, wherein the base layer of the SVC encoded stream comprises more instantaneous decode refresh (IDR) frames than its corresponding enhancement layer stream.

26. The apparatus according to claim 24, wherein the base layer of the SVC encoded stream comprises a shorter group of pictures (GOP) than its corresponding enhancement layer stream.

27. The apparatus according to claim 24, wherein said decoding means is configured to decode all frames in the corresponding enhancement layer stream at the same time while decoding and displaying the buffered packets.

28. A method for displaying a secondary video stream in a secondary display window on a display device, the method comprising the steps of:
Providing a base layer of an SVC encoded stream as the secondary video stream; and
Providing an enhancement layer of the SVC encoded stream as a corresponding regular video stream to the secondary video stream.
